(19) United States
(12) Patent Application Publication
(10) Pub. No.: US 2024/0353555 A1
(43) Pub. Date: Oct. 24, 2024

(54) Method and Apparatus for Automotive Radar Signal Sensing

(71) Applicant: Telefonaktiebolaget LM Ericsson (publ), Stockholm (SE)

(72) Inventor: Raihan Rafique, Lund (SE)

(21) Appl. No.: 18/575,227

(22) PCT Filed: Jun. 29, 2021
(86) PCT No.: PCT/EP2021/067832

§ 371 Date: Dec. 28, 2023

(51) Int. Cl. G01S 13/86; G01S 7/02; G01S 13/88; G01S 13/931; H04B 1/3827

(52) U.S. Cl. CPC G01S 13/86; G01S 7/023; G01S 13/886; G01S 13/931; H04B 1/3833

(57) ABSTRACT

A combined cellular transceiver and automotive radar sensor module (100) comprising a cellular transceiver (110) and an automotive radar sensor (120) is disclosed. The cellular transceiver (110) comprises a receiver (111) and a transmitter (112) configured to operate at millimeter wave frequency. the automotive radar sensor (120) comprises a measurement receiver (130). The measurement receiver (130) comprises a signal probe (131) coupled to an antenna element (113) comprised in the cellular transceiver (110). an amplifier (132) coupled to the signal probe (131) and a power sensor (133) coupled to an output of the amplifier (132) and configured to receive an amplified radar signal from the amplifier (132) and measure the signal strength of the automotive radar signal.

### TECHNICAL FIELD

Embodiments herein relate to a communication device and method therein for automotive radar sensing. In particular, they relate to a combined cellular transceiver and automotive radar sensor module and a communication device comprising the combined cellular transceiver and automotive radar sensor module for measuring automotive radar signal.

### BACKGROUND

Wireless communication devices, e.g. user equipment (UEs) are adopting millimeter (mm) wave frequency to provide high data rate experiences for users. Generally, the mm wave setup in a UE is a transceiver module with multiple antenna elements. A UE may have one or more of such modules, which mostly work in time division duplexing mode.

On the other hand, automobile is also using millimeter wave frequency in its radar module comprising a transmitter and a receiver. The radar modules along with Light Detection and Ranging (Lidar) are appearing common features for cars towards automation. In a street environment, multiple cars with radar modules and multiple pedestrians with UEs are active simultaneously with different communications and may share the same physical space.

Automotive radar modules may work in half duplex mode, which means that immediately after transmitting a signal, the transmitter is turned off and the receiver is activated to receive data. The radar signal is a short pulse within a frequency band which may be a single tone or a modulated signal. The radar signal is sent in combination with Orthogonal Frequency Division Multiplexing (OFDM) with different frequency modulation schemes such as continuous, sweeping, or Frequency-shift keying (FSK).

A pedestrian with a UE on a road, may have his/her attention occupied by data or voice communications of the UE and may not be aware of moving automobiles in the proximity, which is a possible risk for the pedestrian. Further, the mm wave frequency transceiver module in the UE works e.g. at a 39 GHz frequency band, which is half of the automobile radar module operating frequency of 77 GHZ, so the 2nd harmonic signals from the UE may interfere the radar signal of the automobile and saturate the receiver of the automotive radar module.

Thus, there is a need to provide an improved communication device which can increase the safety of a user of the communication device. It would further be beneficial to reduce interference to the automotive radar signal.

### SUMMARY

It is therefore an object of embodiments herein to provide a communication device and method therein for increasing safety of a user of the communication device. A further object of some embodiments is to reduce interferences to automotive radar signals.

As discussed in the background, for some automotive radar systems, the mm wave frequency transceiver module works at half of the automotive radar module operating frequency. Thus, there is already a setup in the communication device which can be used to listen to or communicate with the automotive radar module in the proximity. The solution proposed according to embodiments herein is to add at least one measurement receiver at automotive radar signal frequency for measuring signal strength of one or more automotive radar signals. Some embodiments disclosed herein are operable for other relations between the automotive radar operating frequency and the cellular transceiver operating frequency than a factor of two as well.

According to one aspect of embodiments herein, the object is achieved by a combined cellular transceiver and automotive radar sensor module and method therein for measuring a signal strength of one or more automotive radar signals sent from one or more automobiles. The combined cellular transceiver and automotive radar sensor module comprises a cellular transceiver and an automotive radar sensor. The cellular transceiver comprises a receiver and a transmitter. The automotive radar sensor comprises a measurement receiver. The measurement receiver comprises a signal probe coupled to an antenna element comprised in the cellular transceiver. The signal probe is configured to probe an automotive radar signal sent from one or more automobiles. The measurement receiver further comprises an amplifier coupled to the signal probe and configured to receive and amplify the radar signal output from the signal probe. The measurement receiver further comprises a power sensor coupled to an output of the amplifier and configured to receive an amplified radar signal from the amplifier and measure the signal strength of the automotive radar signal.

According to some embodiments herein, the measurement receiver may be configured to operate in a first and second modes. The first mode is to measure the signal strength of an automotive radar signal when the cellular transceiver is receiving signal, and the second mode is to measure a signal strength of a harmonic signal of the transmitter when the cellular transceiver is transmitting.

According to some embodiments herein, the combined cellular transceiver and automotive radar sensor module may comprise a determining unit configured to cause actions to be performed based on the signal strength measurement result of the automotive radar signal and/or the second harmonic signal of the transmitter.

According to some embodiments herein the actions to be performed may comprise any one or a combination of the following:

Initiating a signal sending to inform automobile proximity to a user of a communication device comprising the combined module;

Initiating an optimization process for the transmitter to reduce its second harmonic signal transmitting; and

Initiating a shutting down of data and/or voice communication of a communication device comprising the combined module.

According to one aspect of embodiments herein, the object is achieved by a communication device and method therein for measuring a signal strength of one or more automotive radar signals sent from one or more automobiles. The communication device comprises a combined cellular transceiver and automotive radar sensor modules described above.

According to some embodiments herein, the communication device may comprise two or more combined modules. The two or more combined modules may spatially be placed at different locations of the communication device to measure one or more automotive radar signals.

According to some embodiments herein the measurement receivers in the two or more combined modules each may comprise a down-conversion chain to convert each of the one or more automotive radar signals to a digital signal, and the communication device comprise a processing unit configured to process the digital signals of the one or more automotive radar signals and estimate positions of one or more approaching automobiles based on the locations of two or more combined modules and the measurements of the one or more automotive radar signals from the measurement receivers.

According to some embodiments herein, the communication device may further comprise a user interface configured to send a signal to a user of the communication device based on the measurements of the one or more automotive radar signals. The signal may be any one or a combination of a vibration, a sound, or a visual signal to inform the user a danger situation.

In other words, according to embodiments herein, a combined cellular transceiver and automotive radar sensor module and a communication device comprising one or more combined cellular transceiver and automotive radar sensor modules are provided. That is at least one automotive radar sensor module comprising a measurement receiver operating at automotive radar frequency is added to the cellular transceiver operating at millimetre wave frequency. The measurement receiver may be used to measure the signal strength of one or more automotive radar signals. The measurement receiver may also be used to measure the signal strength of the harmonic signals of the transmitter in the cellular transceiver. The measurement receiver may reuse receiver hardware, such as antenna elements, mixers, analog to digital converters etc., in the cellular transceiver to receive and down convert the radar signals to digital signals for further processing. The communication device with one or more combined cellular transceiver and automotive radar sensor modules can identify the proximity and direction of one or more automobiles by measuring the signal power of the radar signals sent from the automotive radar modules. The hardware and operations of the combined cellular transceiver and automotive radar sensor module are configurable by switches, so it is possible to listen the automotive radar signal and demodulate the automotive radar signal modulation, acknowledgment/negative acknowledgment (ACK/NACK) communications and interpret the traffic situation around the user. From the harmonic signal power measurement, the communication device can minimize or reduce the harmonics generation e.g. the 2nd or 3rd harmonic, with pre-processing or pre-distortion of the transmitting signal. From the radar signal power measurement, it is possible to warn the user with different mediums, such as vibration, sound, visual alert for possible danger situation, and/or shut down the data or voice communication when necessary.

Therefore, the embodiments herein provide a communication device and method therein with improved performance on increasing safety for users of communication devices and, for some embodiments, reducing interferences to automotive radar signals in a wireless communication network while reusing existing hardware resources in the communication device.

### BRIEF DESCRIPTION OF THE DRAWINGS

Examples of embodiments herein are described in more detail with reference to attached drawings in which:

FIG. 1 is a schematic block diagram illustrating a combined cellular transceiver and automotive radar sensor module according to a first embodiment herein;

FIG. 2 is a schematic block diagram illustrating a combined cellular transceiver and automotive radar sensor module according to a second embodiment herein;

FIG. 3 is a schematic block diagram illustrating a combined cellular transceiver and automotive radar sensor module according to a third embodiment herein;

FIG. 4 is a schematic block diagram illustrating a combined cellular transceiver and automotive radar sensor module according to a fourth embodiment herein;

FIG. 5 is a schematic block diagram illustrating a combined cellular transceiver and automotive radar sensor module according to a fifth embodiment herein;

FIG. 6 is a schematic block diagram illustrating a communication device comprising one or more combined cellular transceiver and automotive radar sensor modules according to embodiments herein;

FIG. 7 is a schematic block diagram illustrating an example scenario where users and automobiles are share the same space; and

FIG. 8 is a flow chart illustrating a method performed in a communication device according to embodiments herein.

### DETAILED DESCRIPTION

More and more communication devices, e.g. UEs, are having mm-wave frequency communication modules. In current context the mm-wave frequency communication modules are supporting operating frequency up to 43 GHZ. That enables users to have high speed data communication to be used in different contexts. One of such a context is a pedestrian context where both the users and moving vehicles use close space and sometimes over lapping space, e.g. at a road crossing.

Based on current standard, automotive radar is operating almost at around the 2nd harmonic of the mm wave communication modules operating at 39 GHz frequency band.

That enables a UE to sniff on the automotive radar signal for Vehicle-to-vehicle (V2V) communication. Based on the information the UE will be able to map different automobiles around the user. Furthermore, that information can be utilized to aware the user for possible danger situation.

According to embodiments herein, it is proposed to add at least an additional measurement receiver for at least one of the mm wave frequency communication module in a communication device. The measurement receiver may be coupled by active or passive structures such as a filter to an antenna of the mm wave frequency communication module. Thus, the measurement receiver can receive and measure signals at the automobile radar signal frequency.

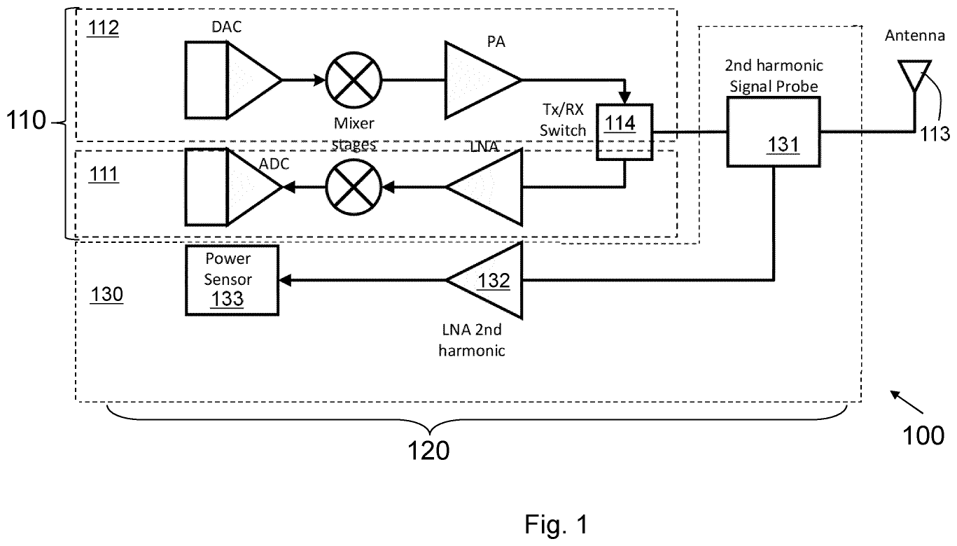

FIG. 1 depicts a schematic block diagram of a combined cellular transceiver and automotive radar sensor module 100 according to a first embodiments herein for measuring automotive radar signals. The combined cellular transceiver and automotive radar sensor module 100 comprising a cellular transceiver 110 and an automotive radar sensor 120. The cellular transceiver 110 comprises a receiver 111 and a transmitter 112, which may be configured to operate at millimeter wave frequency. The automotive radar sensor 120 comprises a measurement receiver 130. The measurement receiver 130 comprises a signal probe 131 coupled to an antenna element 113 comprised in the cellular transceiver 110. The signal probe 131 is configured to probe an automotive radar signal sent from one or more automobiles. The measurement receiver 130 further comprises an amplifier 132 coupled to the signal probe 131 and configured to receive and amplify the radar signal output from the signal probe 131. The measurement receiver 130 further comprises a power sensor 133, coupled to an output of the amplifier 132 and configured to receive an amplified radar signal from the amplifier 132 and measure the signal strength of the automotive radar signal.

According to some embodiments herein, the signal probe 131 may be a high-pass filter or a duplexer with low-pass and high-pass filters configured to have a cut off frequency between the maximum operating frequency of the cellular transceiver 110 and the minimum operating frequency of an automotive radar module, e.g. 43 GHz<fc<77 GHz, where fc is the cut off frequency of the high pass filter.

Although FIG. 1 shows that the 2nd order harmonic signal is to be probed, amplified, and measured, the measurement receiver 130 may be configured to probe, amplify and measure other order harmonic signals, e.g. depending on what frequency bands are used for cellular communications and automotive radar, respectively.

As shown in FIG. 1, the signal probe 131 may be between a transmitter receiver switch TX/RX 114 and the antenna element 113. The TX/RX switch 114 may be a time division duplex (TDD) switch between the transmitter 112 and receiver 111 to select transmitting or receiving in uplink or downlink mode. Furthermore, in a practical design, the antenna element 113 may need to harmonic matching at automotive radar signal frequency.

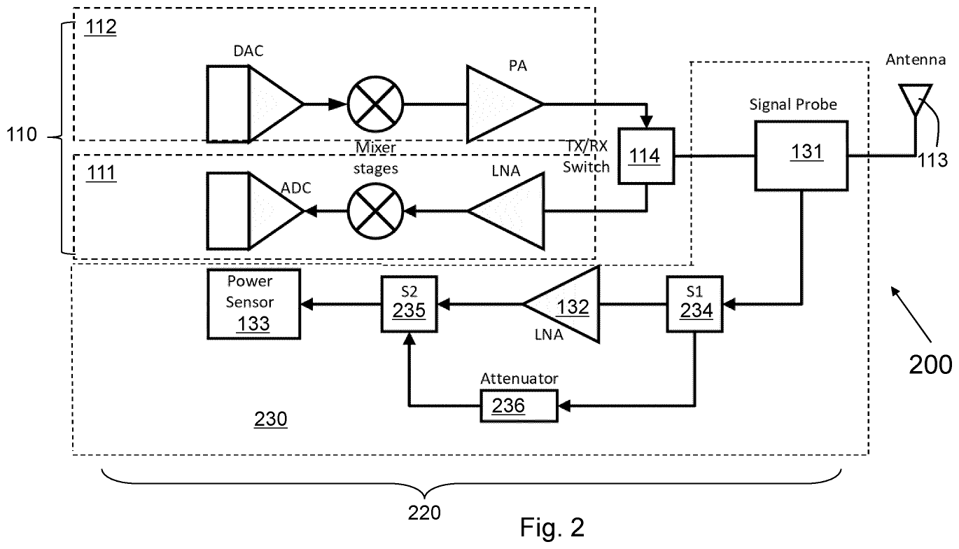

FIG. 2 depicts a schematic block diagram of a combined cellular transceiver and automotive radar sensor module 200 according to a second embodiments herein for measuring automotive radar signals and harmonic signals transmitted by the transceiver module. The combined cellular transceiver and automotive radar sensor module 200 comprises a cellular transceiver 110 and an automotive radar sensor 220 which comprises a measurement receiver 230. Same as the measurement receiver 130 shown in FIG. 1, the measurement receiver 230 comprises a signal probe 131, an amplifier 132 and a power sensor 133. The measurement receiver 230 further comprises a first switch S1 234 coupled between the amplifier 132 and the signal probe 131, a second switch S2 235 coupled between the amplifier 132 and the power sensor 133, and an attenuator 236 coupled between the first and second switches S1, S2.

FIG. 2 is an example setup where the measurement receiver 230 has an amplifier and an attenuator in parallel and controlled by switches. The switches are having a same control as of the TDD TX/RX switch 114 in the cellular transceiver 110. That makes the power senor 133 to get an attenuate signal when the cellular transmitter is emitting and an amplified signal while sensing automobile radar signals. The power sensor 133 will measure the power of any automotive radar signals in the proximity. Then during the uplink mode, the 2nd or higher order harmonic of the transmitting signal will be measured. It is considered the 2nd harmonic components of the transmitting signal may appear much stronger in comparison to the radar signal at the measurement receiver 230 so the attenuator 236 is used to attenuate the 2nd harmonic signal. The 2nd harmonic signal power at the uplink mode may be used to take decision if any pre-processing, such as pre-distortion, is needed for the transmitter 112 to reduce the power of the harmonic signals.

Therefore, according to some embodiments herein, the measurement receiver 230 may be configured to operate in a first and second modes by controlling the first and second switches 234, 235 in the same way as that of the TX/RX switch 114 in the cellular transceiver 110. The first mode, i.e. the downlink mode, is to measure the signal strength of an automotive radar signal through the amplifier 132 when the cellular transceiver 110 is receiving signal. The second mode, i.e. the uplink mode, is to measure the signal strength of the harmonic signal of the transmitter 112 through the attenuator 236 when the cellular transceiver 110 is transmitting.

Each automobile may have own signature of radar signal. By identifying the signatures of radar signals, the communication device will be able to estimate multi vehicle scenarios. For this purpose, the communication device needs to convert the received radar signals to baseband. As the existing mm wave frequency transceiver works at half of the automotive radar signals frequency, it is proposed to use a switch setup in the receiver chains of the transceiver such that hardware resources can be reused.

Therefore, according to some embodiments herein, the cellular transceiver 110 comprises two or more receiver chains, and the measurement receiver uses the same receiver chains to down convert one or more received automotive radar signals for further processing.

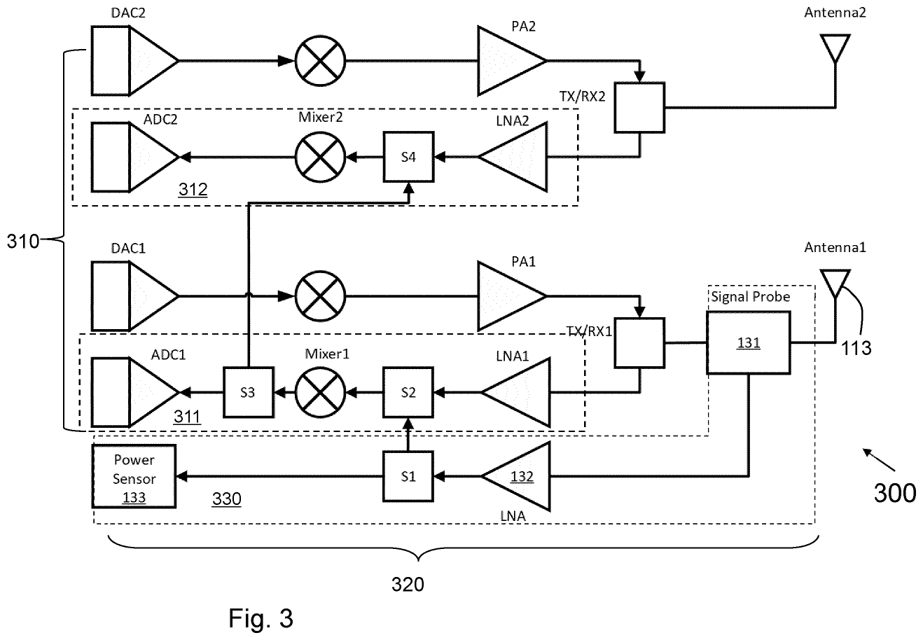

FIG. 3 depicts a schematic block diagram of a combined cellular transceiver and automotive radar sensor module 300 according to a third embodiments herein for measuring automotive radar signals and identify radar signals signatures of individual automobiles. The combined cellular transceiver and automotive radar sensor module 300 comprises a cellular transceiver 310 and an automotive radar sensor 320 which comprises a measurement receiver 330. The cellular transceiver 310 comprises two or more receiver chains 311, 312.

Same as the measurement receiver 130, 230 shown in FIGS. 1 and 2, the measurement receiver 330 comprises a signal probe 131, an amplifier 132 and a power sensor 133.

As shown in FIG. 3, the example switch setup comprises 4 switches S1, S2, S3, S4. The first switch S1 is added in the measurement receiver 330 and connected between the amplifier 132 and the power sensor 133. The second and third switches S2, S3 are added in the first receiver chain 311. The second switch S2 is coupled between a first amplifier LNA1 and a first mixer Mixer1 of the first receiver chain 311, the third switch S3 is coupled between the first mixer Mixer1 and a first analog-to-digital converter ADC1. The fourth switch S4 is added in the second receiver chain 312 and coupled between a second amplifier LNA2 and a second mixer Mixer2 of the second receiver chain 312. The four switches S1, S2, S3, S4 are used to couple the output signal from the amplifier to the first mixer Mixer1 of the first receiver chain 311 and then to the second mixer Mixer2 of the second receiver chain 312 to down convert the amplified radar signal to baseband by down converting twice using the two mixers in the two receiver chains 311, 312 of the cellular transceiver 310. In normal operating mode, the first switch S1 will connect the output of the amplifier 132 to the power sensor 133 while all elements in the first and second receiver chains are connected as usual in their normal operating mode, e.g. the amplifier LNA1 is connected to the Mixer1 and then to the ADC1, the LNA2 is connected to the Mixer2 and then to the ADC2.

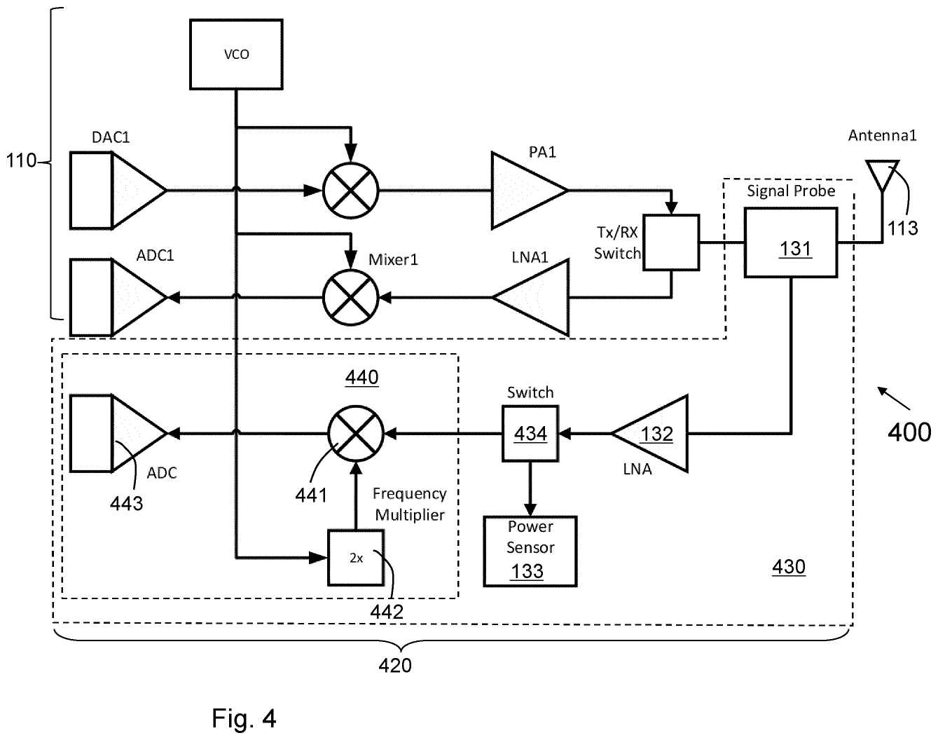

According to some embodiments herein, the measurement receiver may have a dedicated down-conversion chain to convert the received radar signal to digital signals. FIG. 4 depicts a schematic block diagram of a combined cellular transceiver and automotive radar sensor module 400 according to a fourth embodiments herein for measuring automotive radar signals and identify radar signals signatures of individual automobiles. The combined cellular transceiver and automotive radar sensor module 400 comprises a cellular transceiver 110 and an automotive radar sensor 420 which comprises a measurement receiver 430. Same as the measurement receiver 130 shown in FIG. 1, the measurement receiver 430 comprises a signal probe 131, an amplifier 132 and a power sensor 133.

The measurement receiver 430 further comprises a down-conversion chain 440 to down convert one or more received automotive radar signals to digital signals. The down-conversion chain 440 comprises a mixer 441 coupled to the output of the amplifier 132 through a switch 434. The down-conversion chain 440 further comprises a frequency multiplier 442 and an analog to digital converter ADC 443.

During operation, the mixer 441 receives a local oscillator (LO) signal which is multiple of, in this example two times, the LO signal frequency of the transceiver 110 by using the frequency multiplier 442 such that the down-conversion chain 440 can share the same LO signal generator with the transceiver 110, e.g., a voltage controlled oscillator VCO shown in FIG. 4. The down-conversion chain 440 is connected to the LNA 132 to receive and convert the amplified radar signals to digital signals.

According to some embodiments herein, the measurement receiver may have another type of dedicated down-conversion chain to convert the received radar signal to digital signals.

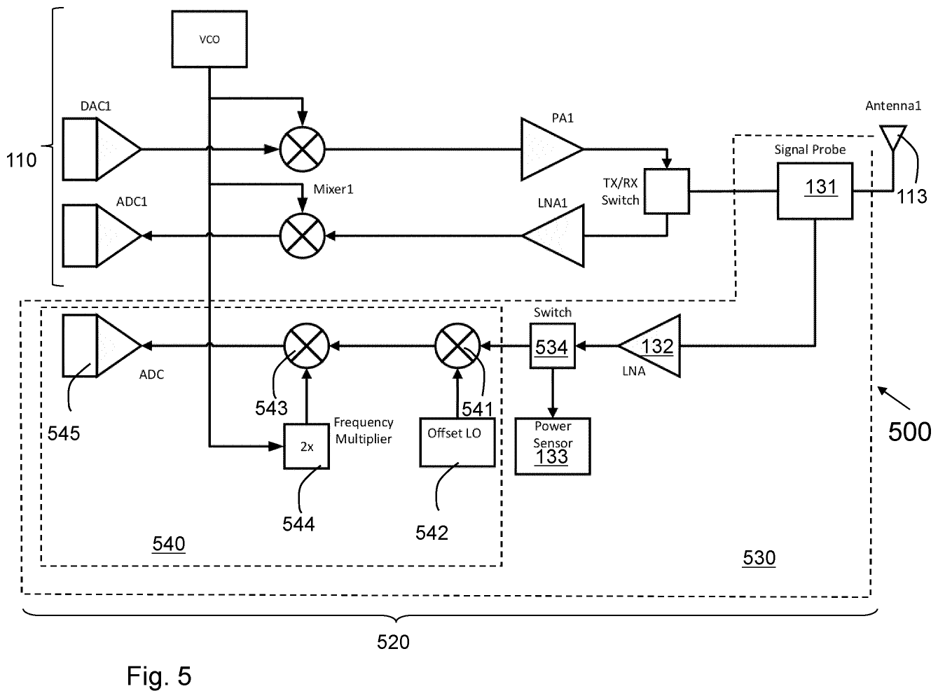

FIG. 5 depicts a schematic block diagram of a combined cellular transceiver and automotive radar sensor module 500 according to a fifth embodiments herein for measuring automotive radar signals and identify radar signals signatures of individual automobiles. The combined cellular transceiver and automotive radar sensor module 500 comprises a cellular transceiver 110 and an automotive radar sensor 520 which comprises a measurement receiver 530. Same as the measurement receiver 130 shown in FIG. 1, the measurement receiver 530 comprises a signal probe 131, an amplifier 132 and a power sensor 133.

The measurement receiver 530 further comprises a down-conversion chain 540 coupled to an output of the amplifier 132 through a switch 534 and configured to down convert one or more received automotive radar signals to digital signals. The down-conversion chain 540 comprises a first mixer 541, an offset local oscillator LO 542, a second mixer 543, a frequency multiplier 544, and an analog to digital converter 545. Compared to the down-conversion chain 440 shown in FIG. 4, the down-conversion chain 540 contains an additional mixer with an offset LO. That is needed to adjust the carrier frequency of the radar signal intendant to the transmitter's operation frequency of the transceiver 110.

The switch 434/534 may route the amplified radar signals between the power sensor 133 and the down conversion chain 440/540. The dedicated down-conversion chain 440/540 mitigates reuse of the ADC in the transceiver 110 and avoids using broadband switches in the receiver chain of the transceiver 110. It is proposed that switching to the down conversion chain 440/540 will happen when the power sensor 133 detects a stronger signal, i.e. the signal strength measured by the power sensor 133 is above a threshold, indicating that automobiles are in proximity and thus need to be assessed further, such as identify the direction, location, velocity, and number of automobiles. The dedicated down-conversion chain 440/540 also helps the radar sensor 420 to work independently without any requirement for any switching between transceiver's communication and radar data signal processing.

The measurement receivers 130, 230, 330, 430, 530 described above according to embodiments herein can measure a signal power of the automotive radar signal through the low noise amplifier LNA 132 and the power sensor 133. Furthermore, the same automotive radar signal can also be routed through two or more sets of down-conversion and demodulation stages of the receivers with two or more antenna elements in the mm wave frequency transceiver 110 with switching network. This enables getting the automotive communications and radar signals in baseband and to be processed based on the radar protocol. Thus, it will be possible to pin-point exact communications and to extract positions or next move information of multiple vehicles.

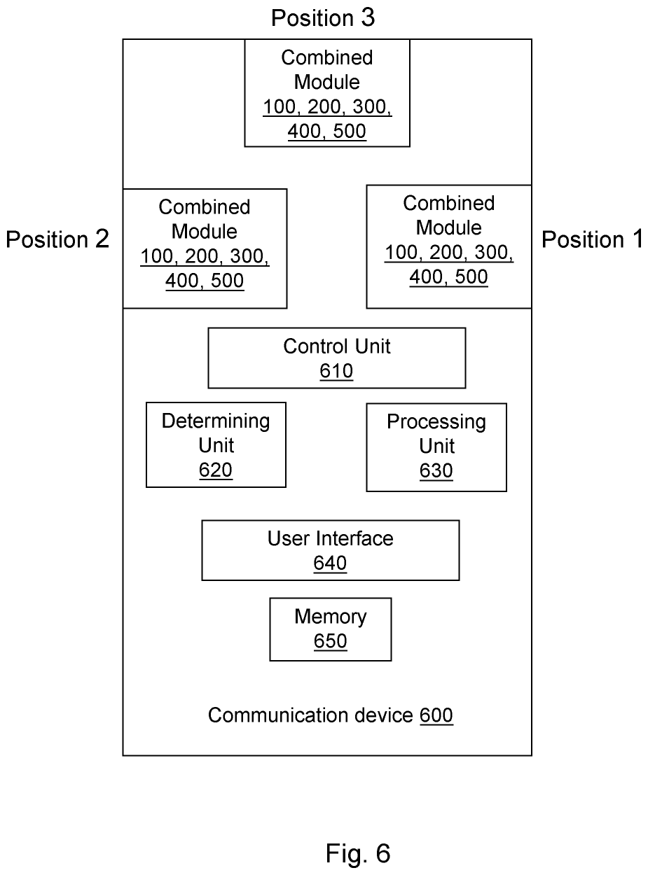

According to some embodiments herein, a communication device may comprise one, two or more combined modules 100, 200, 300, 400, 500 described above. The two or more combined modules 100, 200, 300, 400, 500 may be spatially placed at different locations of the communication device to measure one or more automotive radar signals with beam forming. FIG. 6 shows an example embodiment of a communication device 600, where three combined modules 100, 200, 300, 400, 500 are placed at three different positions, Position 1, 2, 3, of the communication device 600.

The measurement receivers 130, 230, 330, 430, 530 in the one or more combined modules 100, 200, 300, 400, 500 each may comprise a down-conversion chain to convert each of the one or more automotive radar signals to a digital signal. The communication device 600 further comprises a control unit 610 configured to control the operations and switches of the one or more combined modules 100, 200, 300, 400, 500, a processing unit 630 configured to process the digital signals of the one or more automotive radar signals and estimate positions of one or more approaching automobiles based on the locations of the two or more combined modules 100, 200, 300, 400, 500 and the measurements of the one or more automotive radar signals from the measurement receivers 130, 230, 330, 430, 530. For example, if a radar signal is detected by the combined module 100, 200, 300, 400, 500 at Position 1, it indicates that an automobile is in proximity to the right of the communication device 600.

According to some embodiments herein, the communication device 600 may further comprises a user interface 640 configured to send a signal to a user of the communication device based on the measurements of the one or more automotive radar signals. The signal may be any one or a combination of a vibration, a sound, or a visual signal to inform the user a possible danger situation. The communication device 600 may further comprise other units, such as a determining unit 620 etc.

The determining unit 620 may be configured to cause actions to be performed based on the signal strength measurement result of the automotive radar signals and/or the second harmonic signal of the transmitter in the transceiver 110. The actions to be performed may comprise any one or a combination of:
Initiating a signal sending to inform automobile proximity to a user of a communication device comprising the combined module;
Initiating an optimization process for the transmitter to reduce its second harmonic signal transmitting;
Initiating a shutting down of data and/or voice communication of a communication device comprising the combined module.

According to some embodiments herein, the determining unit 620 may be located in the combined cellular transceiver and automotive radar sensor module 100, 200, 300, 400, 500, and configured to cause the actions, e.g. listed above, to be performed based on the signal strength measurement result of the automotive radar signals and/or the second harmonic signal of the transmitter in the transceiver 110.

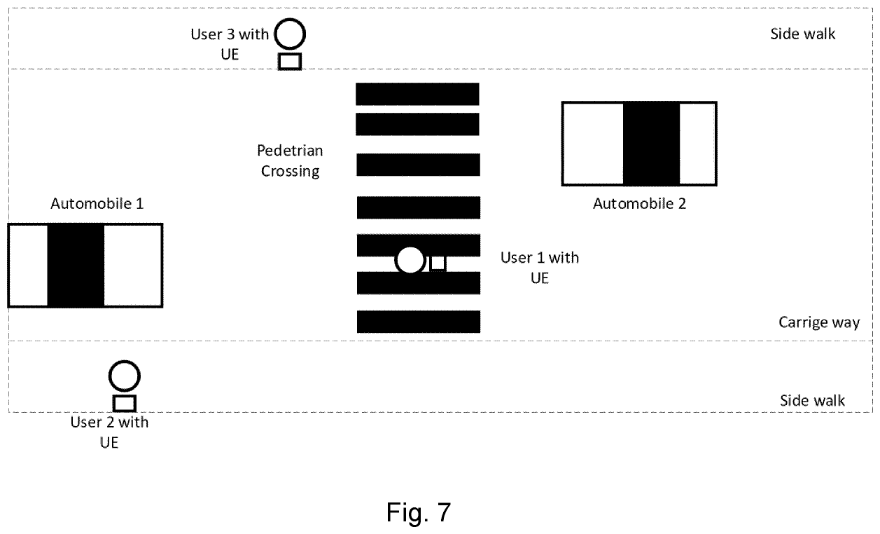

FIG. 7 shows an example scenario, where multiple UEs with respective users and multiple automobiles are share the same space, e.g. at a pedestrian crossing. If the UE of the User 1 comprises one or more combined modules 100, 200, 300, 400, 500, it will be possible to detect that two automobiles are in the proximity to the User 1, one to the left and one to the right of the User 1. Then a signal can be sent to the User 1 to inform the situation or warn the User 1 that there may be a danger, or a shutting down of data and/or voice communication of the UE is initiated when it is necessary.

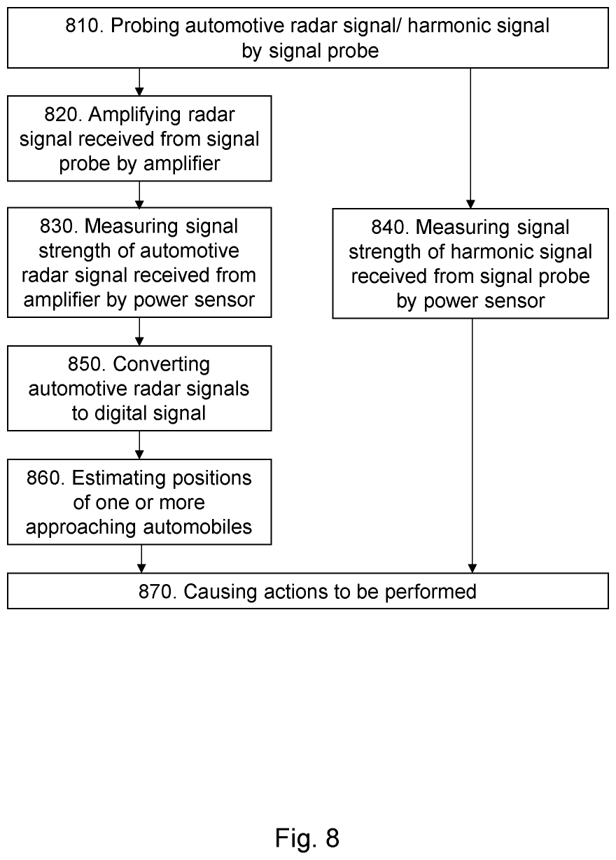

A method performed in the communication device 600 for measuring a signal strength of one or more automotive radar signals sent from one or more automobiles and/or measuring harmonic signals from the transmitter 112 according to embodiments herein will be describe with reference to FIG. 8.

As described above with reference to FIG. 2, the measurement receiver 230 may operate in two modes. The first mode is to measure the signal strength of the automotive radar signal. The second mode is to measure the harmonic signal from the transmitter 112. To measure the signal strength of the automotive radar signal, the method comprises the following actions:

### Action 810

Probing automotive radar signals sent from one or more automobiles by the signal probe 131 coupled to the antenna element 113 comprised in the cellular transceiver 110.

### Action 820

Amplifying the radar signal received from the signal probe 131 in the amplifier 132 coupled to the signal probe 131.

### Action 830

Measuring the signal strength of the automotive radar signal received from the amplifier 132 by the power sensor 133 coupled to an output of the amplifier 132.

To measure the harmonic signal from the transmitter 112, the method comprises the following action:

### Action 840

Measuring the signal strength of the harmonic signal of the transmitter 112 in the power sensor 133 by switching the measurement receiver 230 to the second mode such that a signal output from the signal probe 131 is routed to the power sensor 133 through the attenuator 236.

To improve safety for a user of the communication device and perform necessary actions, it is good to identify the direction, location, velocity, and number of automobiles. The method may further comprise the following actions:

### Action 850

Converting the amplified one or more automotive radar signals to digital signals using a dedicated down conversion chain 440, 540 or using the receiver chains of the transceiver 110. It is proposed that switching to the down conversion chain 440, 540 or the receiver chains of the transceiver 110 will happen when the power sensor 133 detects a stronger signal, i.e. the signal strength measured by the power sensor 133 is above a threshold, indicating that automobiles are in proximity and thus need to be assessed further, such as identify the direction, location, velocity, and number of automobiles etc.

### Action 860

Estimating positions of one or more approaching automobiles based on locations of two or more combined modules 100, 200, 300, 400, 500 comprised in the communication device 600 and the measurements of the one or more automotive radar signals from the measurement receivers 130, 230, 330, 430, 530. Although the presence of multiple automobiles can be detected with one combined cellular transceiver and automotive radar sensor module, to estimate the positions of one or more approaching automobiles, two or more combined cellular transceiver and automotive radar sensor module may be needed.

### Action 870

Causing actions to be performed based on the signal strength measurement result of the automotive radar signal and/or the second harmonic signal of the transmitter. The actions to be performed comprise any one or a combination of:
Initiating a signal sending to inform automobile proximity to a user of a communication device comprising the combined module;
Initiating an optimization process for the transmitter to reduce its second harmonic signal transmitting;
Initiating a shutting down of data and/or voice communication of a communication device comprising the combined module.

Those skilled in the art will appreciate that the control unit 610, the determining unit 620 and the processing unit 630 described above in the communication device 600 may be referred to one circuit/unit, a combination of analog and digital circuits, one or more processors configured with software and/or firmware and/or any other digital hardware performing the function of each circuit/unit. The communication device 600 may comprises other circuit/units, such as one or more memory 650 and may be arranged to be used to store received information, measurements, data, configurations and applications to perform the method herein when being executed in the device 600.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1-18. (canceled)

19. A combined cellular transceiver and automotive radar sensor module comprising a cellular transceiver and an automotive radar sensor, wherein the cellular transceiver comprises a receiver and a transmitter, the automotive radar sensor comprises a measurement receiver, and wherein the measurement receiver comprises:
a signal probe coupled to an antenna element comprised in the cellular transceiver, wherein the signal probe is configured to probe an automotive radar signal sent from one or more automobiles;
an amplifier coupled to the signal probe and configured to receive and amplify the radar signal output from the signal probe;
a power sensor coupled to an output of the amplifier and configured to receive an amplified radar signal from the amplifier and measure the signal strength of the automotive radar signal.

20. The combined module of claim 19, wherein the signal probe comprises a high-pass filter configured to have a cut off frequency between the maximum operating frequency of the cellular transceiver and the minimum operating frequency of an automotive radar module.

21. The combined module of claim 19, wherein the measurement receiver further comprises a first switch coupled between the amplifier and the signal probe, a second switch coupled between the amplifier and the power sensor, and an attenuator coupled between the first and second switches, wherein the measurement receiver is configured to operate in a first and second modes by controlling the first and second switches in the same way as that of a transmitter receiver switch comprised in the cellular transceiver, wherein the first mode is to measure the signal strength of an automotive radar signal through the amplifier when the cellular transceiver is receiving signal, and the second mode is to measure the signal strength of a harmonic signal of the transmitter through the attenuator when the cellular transceiver is transmitting.

22. The combined module of claim 19, wherein the cellular transceiver comprises two or more receiver chains, and wherein the measurement receiver is configured to use the same receiver chains to down convert one or more received automotive radar signals for further processing.

23. The combined module of claim 22, wherein each receiver chain comprises a mixer stage, and wherein the output signal from the amplifier of the measurement receiver is coupled to a first mixer stage and then to a second mixer stage through switches to down convert one or more received automotive radar signals for further processing.

24. The combined module of claim 19, wherein the measurement receiver further comprises a down-conversion chain to down convert one or more received automotive radar signals to digital signals, wherein the down-conversion chain comprises a mixer coupled to an output of the amplifier through a switch, a frequency multiplier and an analog to digital converter.

25. The combined module of claim 19, wherein the measurement receiver further comprises a down-conversion chain coupled to an output of the amplifier through a switch and configured to down convert one or more received automotive radar signals to digital signals, wherein the down-conversion chain comprises a first mixer, an offset local oscillator, a second mixer and a frequency multiplier, and an analog to digital converter.

26. The combined module of claim 19 further comprising a determining unit configured to cause actions to be performed based on the signal strength measurement result of the automotive radar signal and/or the second harmonic signal of the transmitter.

27. The combined module of claim 26, wherein the actions to be performed comprise any one or a combination of:
initiating a signal sending to inform automobile proximity to a user of a communication device comprising the combined module;
initiating an optimization process for the transmitter to reduce its second harmonic signal transmitting;
initiating a shutting down of data and/or voice communication of a communication device comprising the combined module.

28. A communication device comprising one, two or more combined modules of claim 19.

29. The communication device of claim 28, wherein the communication device comprises two or more combined modules and wherein the two or more combined modules are spatially placed at different locations of the communication device to measure one or more automotive radar signals.

30. The communication device of claim 28, wherein the communication device comprises two or more combined modules and wherein the measurement receivers in the two or more combined modules each comprises a down-conversion chain to convert each of the one or more automotive radar signals to a digital signal, and the communication device further comprises a processing unit configured to process the digital signals of the one or more automotive radar signals and estimate positions of one or more approaching automobiles based on the locations of the one or more combined modules and the measurements of the one or more automotive radar signals from the measurement receivers.

31. The communication device of claim 28, further comprising a user interface configured to send a signal to a user of the communication device based on the measurements of the one or more automotive radar signals.

32. The communication device of claim 31, wherein the signal is any one or a combination of a vibration, a sound, or a visual signal to inform the user of a vehicle in proximity of the user.

33. A method performed in a communication device for measuring a signal strength of one or more automotive radar signals sent from one or more automobiles, wherein the communication device comprises one or more combined cellular transceiver and automotive radar sensor modules, wherein each of the combined modules comprises a cellular transceiver and an automotive radar sensor, wherein the cellular transceiver comprises a receiver and a transmitter, the automotive radar sensor comprises a measurement receiver comprising a signal probe, an amplifier and a power sensor, and the method comprises:
probing an automotive radar signal sent from one or more automobiles by the signal probe coupled to an antenna element of the transceiver;
amplifying the radar signal received from the signal probe in the amplifier coupled to the signal probe;
measuring the signal strength of the automotive radar signal in the power sensor coupled to an output of the amplifier.

34. The method of claim 33, further comprising measuring a signal strength of a harmonic signal of the transmitter in the power sensor.

35. The method of claim 33, further comprising:
converting each of the one or more automotive radar signals to a digital signal;
estimating positions of one or more approaching automobiles based on locations of two or more combined modules comprised in a communication device and the measurements of the one or more automotive radar signals from the measurement receivers.

36. The method of claim 33, further comprising causing actions to be performed based on the signal strength measurement result of the automotive radar signal and/or the second harmonic signal of the transmitter, wherein the actions to be performed comprise any one or a combination of:
initiating a signal sending to inform automobile proximity to a user of a communication device comprising the combined module;
initiating an optimization process for the transmitter to reduce its second harmonic signal transmitting;
initiating a shutting down of data and/or voice communication of a communication device comprising the combined module.
